(19) United States
(12) Patent Application Publication
(10) Pub. No.: US 2002/0110346 A1
(43) Pub. Date: Aug. 15, 2002

(54) Optical component and optical component module

(76) Inventors: Kazuhiro Ikeda, Tokyo (JP); Hiroshi Matsuura, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/995,480

(22) Filed: Nov. 28, 2001

(30) Foreign Application Priority Data
Feb. 15, 2001 (JP) 2001-38546

(51) Int. Cl. G02B 6/26; G02B 6/27; G02B 27/28

(52) U.S. Cl. 385/140; 385/11; 359/494

(57) ABSTRACT

An optical variable attenuator constituting an optical component comprises a polarizer, a Faraday rotator, a linear phase shifter, and an analyzer which are successively arranged in the direction of light propagation. The thickness of the linear phase shifter in the direction of light propagation and the angle which the crystal optical axis of the linear phase shifter forms with the transmission axis of the analyzer are set as appropriate so that the linear phase shifter compensates for wavelength and temperature dependences of the Faraday rotator, permitting the optical variable attenuator to exhibit favorable light-attenuation-wavelength and temperature characteristics.

### BACKGROUND OF THE INVENTION

1. Technical Field

The invention relates to an optical component and an optical component module to be used in optical communication systems and the like.

2. Related Art

In recent years, erbium-doped optical fiber amplifiers are rapidly spreading in the field of optical communications. Optical variable attenuators are used for optical output adjustment thereof. In general, optical variable attenuators that are intended for optical communication devices such as an optical fiber amplifier require high speed operations. Optical variable attenuators intended for wavelength division multiplexing (WDM) systems require that their light attenuations should not vary depending on wavelengths and temperatures. The reason for this is that the WDM systems in which signal lights of different wavelengths are multiplexed for transmission may drop in transmission quality if the signal lights vary in intensity from one channel to another. This requires that the signal lights be identical in intensity (light quantity) over the entire use waveband, and that the intensity variations of the signal lights resulting from temperature changes be suppressed.

In order to meet the request for high speed operations, there has been proposed an optical variable attenuator which utilizes the Faraday effect to allow electromagnetic control over its light attenuation. The optical variable attenuator according to this proposal, however, is far from being excellent in light attenuation-wavelength and -temperature characteristics and thus is inappropriate to WDM systems as compared to optical variable attenuators of other configurations, e.g., an optical variable attenuator in which a light absorption member having an optical attenuation film that varies in thickness in the transverse direction of the optical path is mechanically moved along the transverse direction of the optical path to change the light attenuation. The optical variable attenuator of the foregoing proposal also has the problem that its light attenuation varies drastically with changes in wavelength and temperature, at higher light attenuations in particular.

### SUMMARY OF THE INVENTION

An object of the present invention is to provide an optical component and an optical component module which have the favorable light-attenuation-wavelength and -temperature characteristics that the light attenuation hardly varies with wavelengths and temperatures.

An optical component according to an aspect of the present invention comprises: an optical component element having a wavelength dependence and a temperature dependence in polarization transformation; and a linear phase shifter arranged on an optical propagation path together with the optical component element. Here, the type of a birefringent crystal constituting the linear phase shifter, the direction of an optical axis of the linear phase shifter, and the thickness of the linear phase shifter in the direction of light propagation are selected so that the linear phase shifter has at least either one of such wavelength and temperature dependences in polarization transformation as allow compensation for at least either one of the wavelength and temperature dependences of the optical component element.

According to the present invention, the component material, the direction of the optical axis, and the thickness of the linear phase shifter can be selected as appropriate to render the wavelength and/or temperature dependence(s) of the polarization transformation of the linear phase shifter capable of compensation for the wavelength and/or temperature dependence(s) of the polarization transformation of the optical component element such as a Faraday rotator. Consequently, the optical component such as an optical variable attenuator is provided with favorable light-attenuation-wavelength and/or -temperature characteristics, and becomes suitably for use in, e.g., a WDM system.

An optical component module according to another aspect of the present invention comprises: a first optical component having a wavelength dependence and a temperature dependence in light attenuation; and a second optical component having a linear phase shifter and being arranged on an optical propagation path together with the first optical component. Here, the type of a birefringent crystal constituting the linear phase shifter, the direction of an optical axis of the linear phase shifter, and the thickness of the linear phase shifter in the direction of light propagation are selected so that the second optical component has at least either one of such wavelength and temperature dependences in light attenuation as allow compensation for at least either one of the wavelength and temperature dependences of the first optical component.

According to the optical component module of the present invention, the component material, the direction of the optical axis, and the thickness of the linear phase shifter can be selected as appropriate to constitute the second optical component including the linear phase shifter that is provided with the required light-attenuation-wavelength and/or -temperature characteristic(s). This makes it possible for the second optical component to compensate for the wavelength and/or temperature dependence(s) of the light attenuation of the first optical component to be compensated. As a result, the optical component module of the present invention excels in light-attenuation-wavelength and/or -temperature characteristic(s).

### BRIEF DESCRIPTION OF THE DRAWINGS

FIG. 1 is a schematic perspective view showing an optical variable attenuator, or the optical component according to a first embodiment of the present invention;

FIG. 2 is a schematic plan view showing field applying and controlling means for applying a magnetic field to a Faraday rotator;

FIG. 3 is a graph showing the light-attenuation-wavelength characteristics of the optical variable attenuator shown in FIG. 1;

FIG. 4 is a graph showing the light-attenuation-temperature characteristics of the optical variable attenuator;

FIG. 5 is a graph showing the relationship between a function kk2 and the thickness of the linear phase shifter, to be used for determining the optical axis angle and thickness of the linear phase shifter in relation to the wavelength characteristics of the optical variable attenuator;

FIG. 6 is a graph showing the light-attenuation-wavelength characteristics of the optical variable attenuator that contains a linear phase shifter having such an optical axis angle and a thickness as decrease the value of the function kk2;

FIG. 7 is a graph showing the relationship between a function kk and the thickness of the linear phase shifter, to be used for determining the optical axis angle and thickness of the linear phase shifter in relation to the temperature characteristics of the optical variable attenuator;

FIG. 8 is a graph showing the light-attenuation-temperature characteristics of the optical variable attenuator that contains a linear phase shifter having such a crystal optical axis angle and a thickness as decrease the value of the function kk;

FIG. 9 is a graph showing the light-attenuation-wavelength characteristics of the optical variable attenuator having the temperature characteristics shown in FIG. 8;

FIG. 10 is a schematic perspective view showing an optical variable attenuator according to a second embodiment of the present invention;

FIG. 11 is a block diagram showing an optical component module according to a third embodiment of the present invention;

FIG. 12 is a graph showing the light-attenuation-wavelength characteristics of the second optical component which constitutes part of the optical component module shown in FIG. 11;

FIG. 13 is a graph showing the light-attenuation-wavelength characteristics of the optical component module shown in FIG. 11 and the first and second optical components constituting the same;

FIG. 14 is a graph showing the wavelength characteristics of a function A contained in the equation of a light attenuation pertaining to the second optical component in which the linear phase shifter is placed at an optical axis angle of 45°;

FIG. 15 is a graph showing the wavelength characteristics of a function cos 2θ contained in the equation of a light attenuation of the second optical component;

FIG. 16 is a graph showing the wavelength characteristics of the function A contained in the equation of a light attenuation pertaining to the second optical component in which the linear phase shifter is placed at an optical axis angle of 80°;

FIG. 17 is a schematic perspective view showing an optical variable attenuator having no linear phase shifter;

FIG. 18 is a graph showing the light-attenuation-wavelength characteristics of the optical variable attenuator shown in FIG. 17; and

FIG. 19 is a graph showing the light-attenuation-temperature characteristics of the optical variable attenuator shown in FIG. 17.

### DETAILED DESCRIPTION

Hereinafter, an optical component according to a first embodiment of the present invention will be described with reference to the drawings.

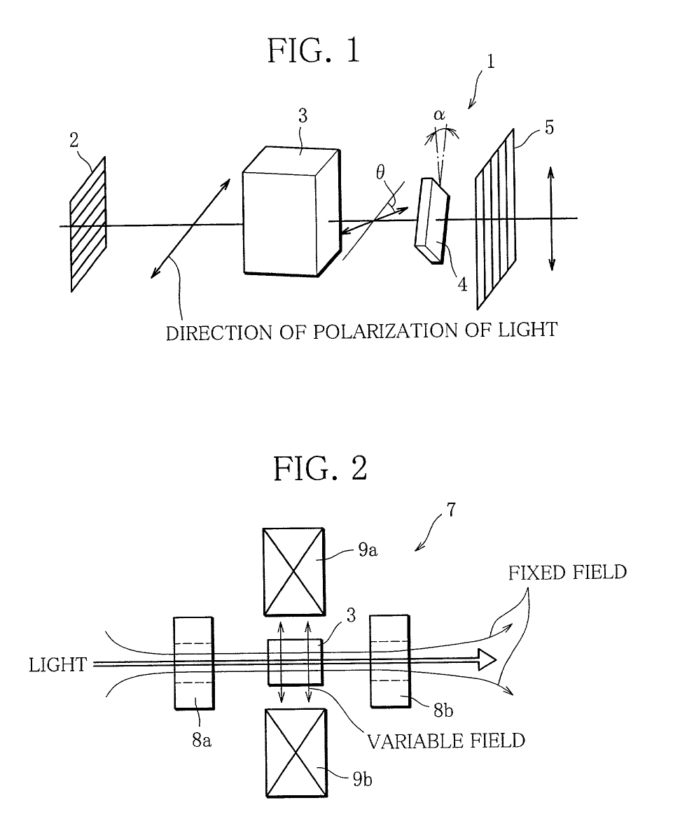

As shown in FIG. 1, the optical component of the present embodiment is constituted as an optical variable attenuator 1 comprising a polarizer (first polarizer) 2, a Faraday rotator 3, a linear phase shifter 4, and an analyzer (second polarizer) 5. The polarizing elements 2-5 are arranged in this order from the incident side to the emergent side of the optical variable attenuator 1 as seen in the direction of propagation of light.

In the optical variable attenuator 1, incident light is transmitted through the polarizer 2 and incident on the Faraday rotator 3, to have its plane of polarization rotated by the Faraday effect from the Faraday rotator 3. Here, the polarization rotation by the Faraday effect exerts light attenuation, because the analyzer 5 kills the coming light apart from the liner polarization light along the transmission axis of the analyzer 5. It is undesirable that this polarization rotation angle vary drastically depending on the wavelength of the light and the ambient temperature. Then, in the present embodiment, the wavelength and temperature dependences of the polarization rotation angle of the Faraday rotator 3 are compensated for by the linear phase shifter 4. The light that emerges from the linear phase shifter 4 is polarized by the analyzer 5.

The polarizers 2 and 5 of this embodiment are placed with their transmission axes orthogonal to each other. However, the arrangement of the polarizers 2 and 5 is not limited thereto. The polarizers may be appropriately arranged so that the directions of their transmission axes conform to the coverage of the Faraday rotation angle of the Faraday rotator 3.

The optical variable attenuator 1 includes the Faraday rotator 3 made of a magnetooptic crystal, such as YIG (yttrium iron garnet), and field applying and controlling means (shown with a reference numeral 7 in FIG. 2) for applying a magnetic field thereto. A magnetic field is applied to the Faraday rotator 3 to magnetize the Faraday rotator 3 so that the plane of polarization of the incident light is rotated by the angle according to the magnitude of magnetization of the Faraday rotator 3 in the direction of light propagation.

The light attenuation of the optical variable attenuator 1 is determined by the rotation angle (Faraday rotation angle) θ which the Faraday rotator 3 yields to the plane of polarization of the light. Therefore, the magnitude of the magnetization in the direction of light propagation, induced in the Faraday rotator 3 by field application, can be changed to vary the light attenuation of the optical variable attenuator 1.

Now, if a magnetooptic crystal is in the state of a multi-domain structure in which numbers of agglomerations of minute magnetizations, or so-called magnetic domains, exist in the crystal, then diffraction losses at the boundaries of those magnetic domains cause an optical transmission loss. On the other hand, when a magnetic field is applied to the magnetooptic crystal, the domains gradually grow into larger domains. The domains are eventually integrated to enter a state of saturation magnetization, with a reduction in the optical transmission loss resulting from domain boundaries.

In the present invention, the Faraday rotator (magnetooptic crystal) 3 is maintained at the saturation-magnetization state while the magnetization component of the Faraday rotator 3 in the direction of light propagation is variably controlled in magnitude, so as to vary the light attenuation while suppressing the optical transmission loss. For that purpose, the field applying and controlling means 7 are used to implement such a magnetization control.

Referring to FIG. 2, the field applying and controlling means 7 include permanent magnets 8a and 8b for creating a fixed field and electromagnets 9a and 9b for creating a variable field. The permanent magnets 8a, 8b are placed on both sides of the Faraday rotator 3 as seen in the direction of light propagation. The electromagnets 9a, 9b are placed on both sides of the Faraday rotator 3 as seen in a direction orthogonal to the direction of the fixed field (more generally, in a direction different from that of the fixed field).

For light attenuation control, the variable field is varied so that the magnitude of the composite field of the fixed and varied fields is modified to change the Faraday rotation angle θ. As concerns the control of the composite field, the permanent magnets 8a and 8b are configured so that a fixed field having an magnitude greater than or equal to the saturation field of the Faraday rotator 3 is formed around the Faraday rotator 3. The variable field is then varied within such a range that the composite field never falls below the saturation field of Faraday rotator 3 in magnitude. In this case, although the magnitude of the composite field varies, the magnitude of magnetization in the magnetooptic crystal does not vary. With a variation of the composite field direction, only the direction of the saturation magnetization varies. Inasmuch as the component of the magnetization in the direction of light propagation varies with a variation of the direction of the saturation magnetization, the light attenuation control can be achieved with a reduced optical transmission loss. Moreover, since the light attenuation is controlled through the electric control of changing the amount of a current fed to the electromagnets 9a and 9b, the light attenuation control can be performed with high precision.

As mentioned previously, the optical component consisting of the optical variable attenuator 1 includes the Faraday rotator 3 as an optical component element having a wavelength dependence and a temperature dependence inducing light attenuation. Hereinafter, description will be given of wavelength and temperature dependences in the Faraday rotation angle θ of the Faraday rotator 3 and the optical variable attenuator having the Faraday rotator 3.

The Faraday rotation angle θ is given by the following equation (1):

θ=K·M·S. (1)

Here, K is the Kundt's constant which expresses the strength of the Faraday effect in a material. M is the magnitude of magnetization along the optical axis of the magnetooptic crystal that constitutes the Faraday rotator 3, and S the optical path length.

The Kundt's constant K varies with materials that make the Faraday rotator 3. Even in the same material, it varies depending on the wavelength of incident light and the ambient temperature, and thus has wavelength and temperature dependences. For this reason, the Faraday rotation angle 0 to be expressed as a function of the Kundt's constant K also has wavelength and temperature dependences. The Faraday rotation angle θ is then expressed as a function of a wavelength λ and a temperature T, or θ (θ0,λ,T). Here, θ0 is the Faraday rotation angle θ for situations where light having a set center wavelength (1.55 μm, for example) is incident on the Faraday rotator 3 that is put under the environment of a set temperature (25° C., for example).

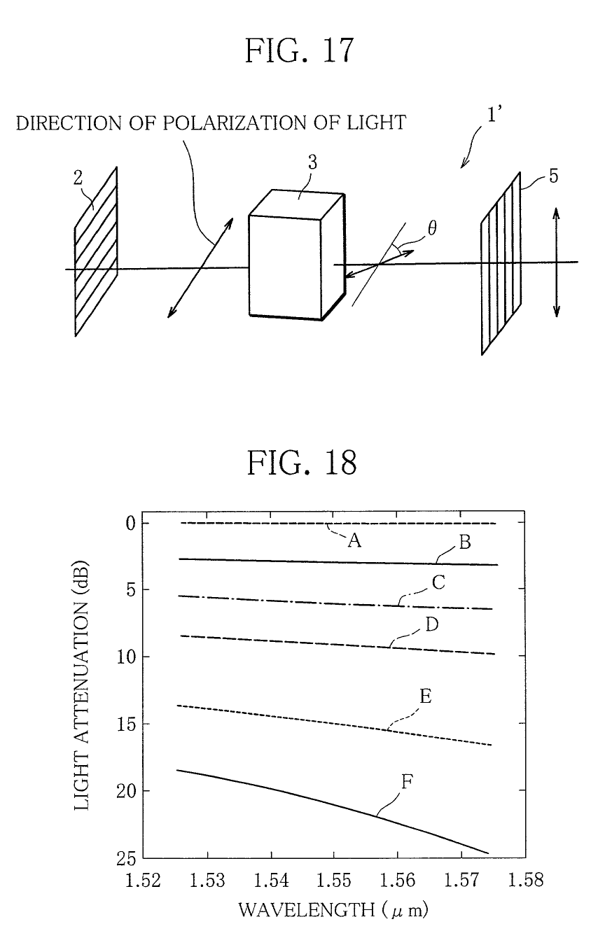

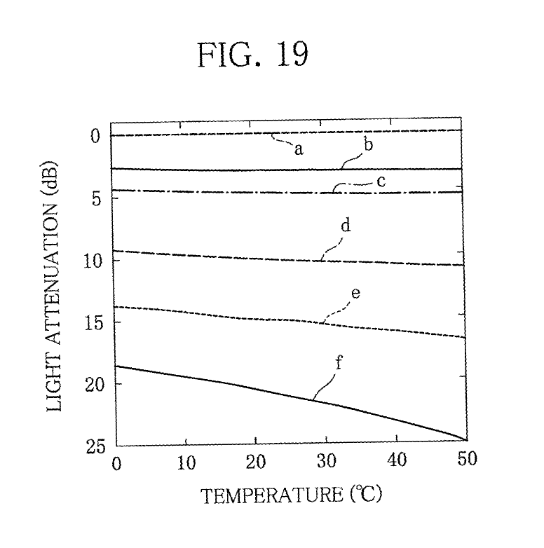

To examine the wavelength and temperature dependences of the optical variable attenuator including the Faraday rotator 3, the present inventors assumed an optical variable attenuator 1′ comprising the polarizer 2, the Faraday rotator 3, and the analyzer 5 arranged in this order in the direction of light propagation as shown in FIG. 17. The optical variable attenuator 1′ was simulated for light attenuations under varied wavelengths of incident light, ambient temperatures, and fields applied (Faraday rotation angles θ). The result of the calculation is shown in FIGS. 18 and 19.

In FIG. 18, the lines A through F represent the light-attenuation-wavelength characteristics of the optical variable attenuator 1′ for Faraday rotation angles θ of 90°, 45°, 30°, 20°, 10°, and 5°, respectively. In FIG. 19, the lines a through f represent the light-attenuation-temperature characteristics of the optical variable attenuator 1′ for Faraday rotation angles θ of 90°, 45°, 35°, 18°, 10°, and 5°, respectively. It can be seen from FIGS. 18 and 19 that the light attenuation of the optical variable attenuator 1′ varies depending on the wavelength, the temperature, and the Faraday rotation angle θ.

The light attenuation L of the optical variable attenuator 1′ shown in FIG. 17 can also be expressed by the following equation (2) which is derived from Mueller-matrix-based operations in optical theories.

L(θ0,λ,T)=10·log₁₀ [(½)·(1−cos 2θ(θ0,λ,T))] (2)

The equation (2) shows that the light attenuation L of the optical variable attenuator 1′ is expressed as a function of the wavelength λ and the temperature T, and thus the light attenuation L has wavelength and temperature dependences.

As has been mentioned briefly, the optical variable attenuator 1 is configured so that the wavelength and temperature dependences of the light attenuation L of the optical variable attenuator 1, resulting from the wavelength and temperature dependences of the Faraday rotation angle θ, are compensated for by the linear phase shifter 4. Hereinafter, description will be given in detail of the linear phase shifter 4.

The linear phase shifter 4 is made of a birefringent crystal, such as quartz and a rutile crystal. A birefringent crystal has different refractive indexes in the direction of its optical axis and a direction orthogonal thereto. Therefore, light propagating through the birefringent crystal is separated into a component polarized in the direction of the optical axis and a component polarized in the direction orthogonal to the optical axis, with a phase difference Δ therebetween. In the present embodiment, the linear phase shifter 4 is placed with its optical axis on a plane orthogonal to the direction of light propagation.

The phase difference Δ between the light components separated by the linear phase shifter 4 is given by the following equation (3):

Δ(λ,T,d)=2π·n(λ,T)·d·(1/λ). (3)

Here, n(λ,T) is the birefringence index of the birefringent crystal making the linear phase shifter 4, and is expressed as a function of the wavelength λ and the temperature T. Then, d represents the thickness of the linear phase shifter 4 in the direction of light propagation.

As in the case of the optical variable attenuator 1′ shown in FIG. 17, Mueller-matrix-based calculations yield the following equation (4) which expresses the light attenuation L1 of the optical variable attenuator 1 in FIG. 1:

L1(θ0,αd,λT)=10·log₁₀ [(½)·{1−(cos 2θ(θ0,λT)+A(θ0,α,d,λ,T))}]. (4)

The function Aθ0,α,d,λ,T) in the equation (4) is given by the following equation (5), and a function C(θ0,α,λ,T) in the equation (5) is given by the following equation (6). In the equations (4) through (6), a is a tilt angle that is formed between the transmission axis of the analyzer 5 and the optical axis of the linear phase shifter 4 (hereinafter, referred to as a crystal optical axis angle). In more general terms, the optical axis angle a represents the direction of the optical axis of the linear phase shifter 4.

A(θ0,αd,λ,T)={1−cos (Δ(λ,T,d))}C(θ0,α,λT) (5)

C(θ0,α,λ,T)=sin 2α·sin 2(θ(θ0, λ,T)−α) (6)

As can be seen from a comparison between the equation (4) which expresses the light attenuation L1 of the optical variable attenuator 1 and the equation (2) which expresses the light attenuation L of the optical variable attenuator 1′, the equation (4) is the equation (2) having the function A(θ0,α,d,λ,T) added to its antilogarithmic term. Therefore, if the wavelength and temperature characteristics of the function A are controllable, it is possible to compensate for the wavelength and temperature dependences of the light attenuation resulting from the Faraday rotator 3.

It can be seen from the equations (3), (5), and (6) that the wavelength and temperature characteristics of the function A are determined by the three variables n, α, and d exclusive of the light attenuation control parameter (Faraday rotation angle) θ0. These three variables, namely, the birefringence index n(λ,T), the crystal optical axis angle α, the thickness d in the direction of light propagation of the birefringent crystal making the linear phase shifter 4 can be set artificially by selecting the material, the angle of arrangement, and the dimensions of the birefringent crystal. Therefore, when the variables n, α, and d are appropriately set to establish the wavelength and temperature characteristics of the function A as appropriate, the light-attenuation-L1-wavelength and -temperature characteristics of the optical variable attenuator 1 can be rendered suitable.

Hereinafter, description will be given of a concrete example of how to set the crystal optical axis angle a and the thickness d of the linear phase shifter 4.

Considering that the optical axis angle a and the thickness d may have an effect on both the wavelength and temperature characteristics of the optical variable attenuator 1, an optical axis angle α and a thickness d to obtain a favorable wavelength characteristic are initially determined as a first combination. In the meantime, an optical axis angle a and a thickness d for a favorable temperature characteristic are determined as a second combination. Finally, a combination of an optical axis angle a and a thickness d for both favorable wavelength and temperature characteristics is obtained on the basis of the first and second combinations.

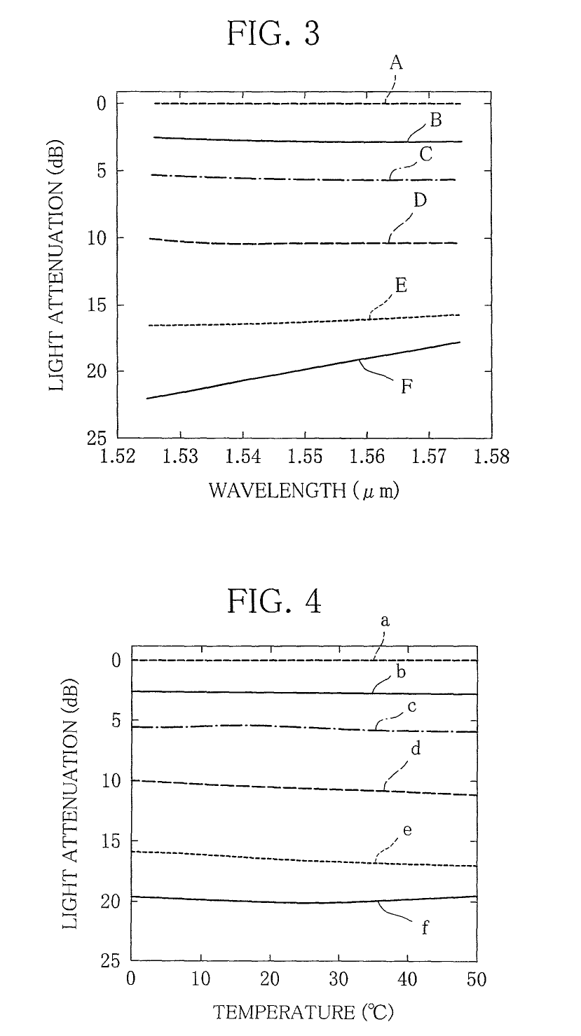

To determine the first combination of the optical axis angle a and the thickness d, such values of the variables a and d as minimize a variation in the light attenuation with respect to a change in the wavelength λ across the entire range of wavelength changes (corresponding to the use waveband) are obtained so as to reduce the wavelength dependence of the light attenuation. Here, the variation in the light attenuation corresponds to the gradients of the light-attenuation-wavelength characteristic lines that are shown in FIG. 3 by way of example. It also corresponds to a value determined by the following equation (7). Specifically, optical axis angles a and thicknesses d at which the function kk2(α,d) given by the following equation (8) takes an extreme value are determined, assuming a use waveband of k1-k2, the material of the linear phase shifter 4 (with the birefringence index n(λ,T)), the ambient temperature T having a value T0, and the Faraday rotation angle θ in the range of variations θ1-θ2.

dLdλ(θ0,αd,λ)=|dL(θ0,α,d,λT0)/dλ| (7)

kk2(α,d)=∫∫_{θ1λ1}^{θ2λ2} dLdλ (θ0,αd,λ)dλdθ (8)

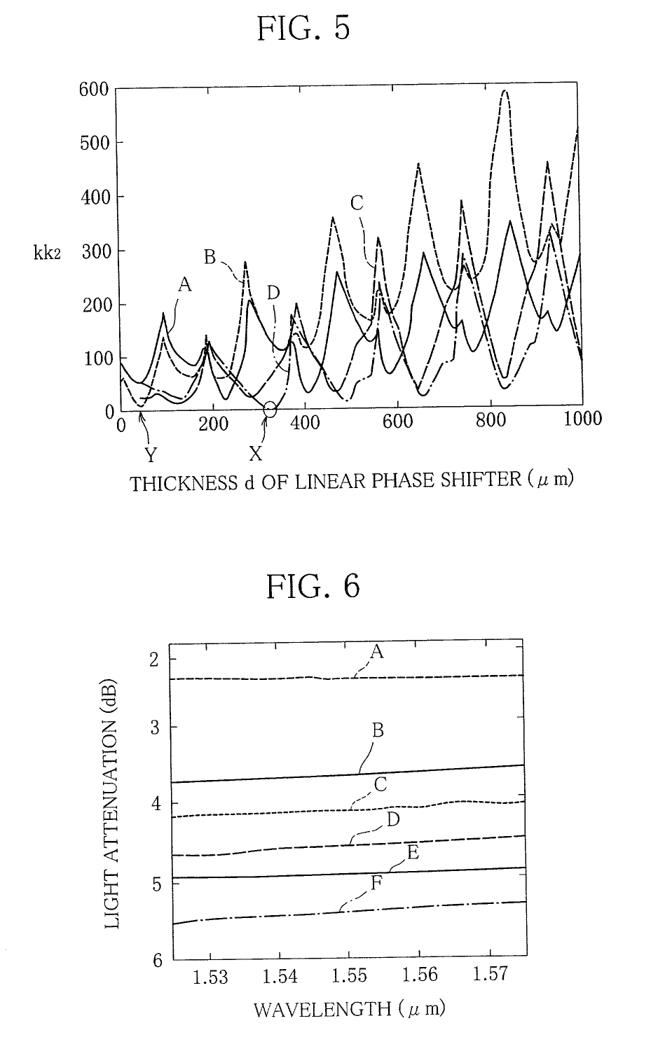

To determine the crystal optical axis angle α and the thickness d to minimize the foregoing function kk2, for example, quartz is selected for the material of the linear phase shifter 4, and the temperature T0, the use waveband λ1-λ2, and the range of changes θ1-θ2 of the Faraday rotation angle are set at 25° C., 1.525-1.575 μm, and 0-90°, respectively. Under these settings, values of the function kk2 are calculated on different values of the crystal optical axis angle α and the thickness d. FIG. 5 shows the calculations as four function-kk2-thickness-d characteristic lines. In FIG. 5, the lines A-D correspond to optical axis angles α of 10°, 30°, 60°, and 80°, respectively.

As indicated with a symbol X in FIG. 5, it is shown that the function kk2 takes an extreme value at a thickness d of approximately 350 μm on the line D. Thus, the optical axis angle α and the thickness d for a favorable wavelength characteristic are determined to be approximately 80° and approximately 350 μm, respectively.

Incidentally, as indicated with a symbol Y in FIG. 5, the function kk2 falls to a fairly small value at an optical axis angle a of approximately 30° and a thickness d of approximately 50 μm. Then, under the condition of α=30° and d=50 μm, light-attenuation-wavelength characteristics of the optical variable attenuator 1 were obtained with Faraday rotation angles θ0 of 0°, 5°, 10°, 20°, 60°, and 90°. The results are shown in FIG. 6. In FIG. 6, the lines A through F represent the light-attenuation-wavelength characteristics for Faraday rotation angles θ of 90°, 0°, 5°, 10°, 60°, and 20°, respectively. FIG. 6 reveals that the light attenuation makes no linear variations with respect to the change of the Faraday rotation angle θ0 and has a narrow range of variations. Thus, it is shown that, in order to broaden the variable range of light attenuation, the condition indicated with the symbol X is preferable to the condition indicated with the symbol Y in FIG. 5 to making the optical variable attenuator 1.

As described above, if the settings of the optical axis angles α and thicknesses d for favorable wavelength characteristics include a plurality of combinations of an optical axis angle α and a thickness d that give the function kk2 an extreme value, then practically-available one is selected out of those combinations.

Next, to determine the combination of an optical axis angle a and a thickness d for a favorable temperature characteristic, the temperature dependence of the light attenuation of the optical variable attenuator 1 be reduced. To this end, a combination of the variables α and d is obtained that minimizes a variation in light attenuation (the gradients of the light-attenuation-temperature curves illustrated in FIG. 4, or the value expressed by the following equation (9)) with respect to a change in temperature access the assumable range of ambient temperature changes. For that purpose, an optical axis angle α and a thickness d at which the function kk(α,d) given by the following equation (10) takes the minimum value are obtained.

dLdT(θ0,α,d,T)=|dL(θ0,α,d,λ0,T)/dT| (9)

kk(α,d)=∫∫_{θ1T1}^{θ2T2} dLdT(θ0,α,d,T)dTdθ (10)

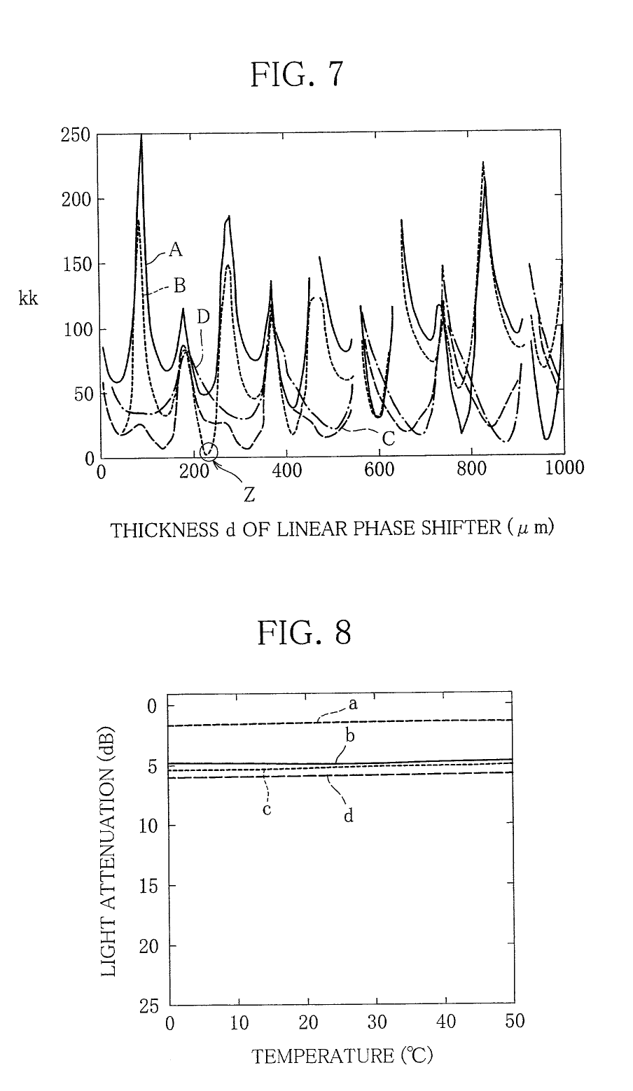

In order to obtain optical axis angles α and thicknesses d at which the function kk takes an extreme value, for example, quarts is selected for the material of the linear phase shifter 4, and the wavelength θ0, the range of temperature changes T1-T2, and the range of changes θ1-θ2 of the Faraday rotation angle θ0 are set at 1.55 μm, 0° C.-50° C., and 0°-90°, respectively. Under these settings, the relationships of the value of the function KK to the optical axis angle α and the thickness d are obtained. FIG. 7 shows the results.

In FIG. 7, the lines A-D correspond to optical axis angles α of 10°, 30°, 60°, and 80°, respectively.

As indicated with a symbol Z in FIG. 7, the function kk falls to the minimum value at a crystal optical axis angle α of approximately 30° on the line B. This means that the optical axis angle α and the thickness d for a favorable temperature characteristic are approximately 30° and approximately 225 μm, respectively.

Under this condition, the light-attenuation-temperature characteristics of the optical variable attenuator 1 were determined for various values of the Faraday rotation angle θ0. FIG. 8 shows the results. In FIG. 8, the symbols a-d represent the light-attenuation-temperature characteristics for Faraday rotation angles θ0 of 90°, 0°, 5°, and 30°, respectively. The temperature characteristics are found to be favorable.

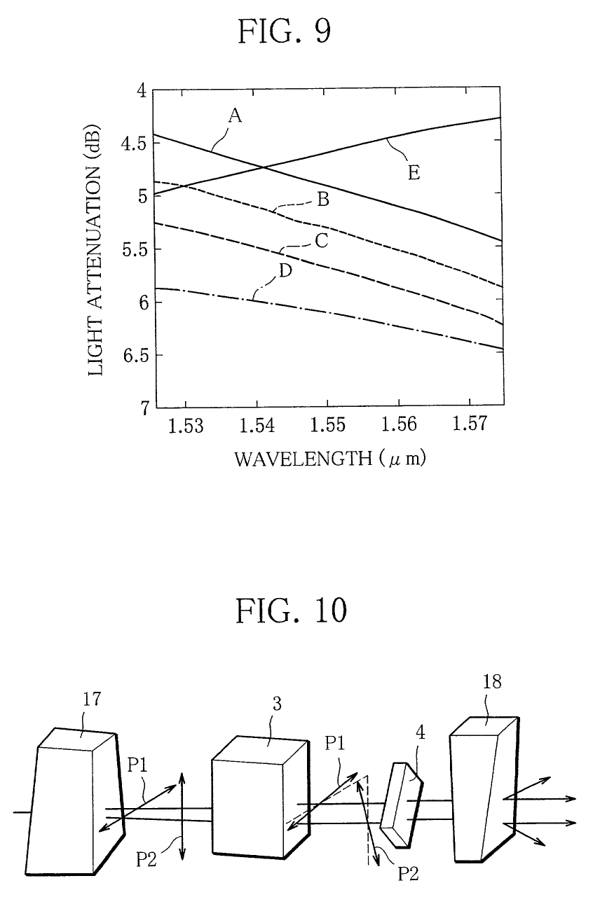

Under the foregoing condition, however, the light attenuation not only has a great dependence on wavelengths as shown in FIG. 9 but also makes no great variation with respect to a change in the Faraday rotation angles θ. Such a condition is inappropriate to making the optical variable attenuator 1. Incidentally, the lines A-E shown in FIG. 9 represent the light-attenuation-wavelength characteristics for Faraday rotation angles θ of 0°, 5°, 10°, 20°, and 50°, respectively.

In the concrete example described above, the optical axis angle α and the thickness d are preferably set at, e.g., 80° and 350 μm, respectively, so that the values of both the functions kk2 and kk are lowered for the sake of favorable wavelength and temperature characteristics. FIGS. 3 and 4 respectively show the wavelength and temperature characteristics of an optical variable attenuator that is configured under this condition. The lines A-F of FIG. 3 and the lines a-f of FIG. 4 represent the light-attenuation-wavelength characteristics and the light attenuation-temperature characteristics for Faraday rotation angles θ of 90°, 45°, 30°, 15°, 5°, and 0°, respectively.

As can be seen from FIGS. 3 and 4, by setting the crystal optical axis angle a and the thickness d in the direction of light propagation of the linear phase shifter 4 to appropriate values, favorable wavelength and temperature characteristics of the optical variable attenuator can be attained because the wavelength and temperature dependences of the light attenuation of the optical variable attenuator, resulting from the Faraday rotator 3, can be compensated.

Hereinafter, further description will be given in this regard. From a comparison between the wavelength characteristics (FIG. 3) of the optical variable attenuator having the linear phase shifter 4 (α=80°, d=350 μm) and the wavelength characteristics (FIG. 18) of the optical variable attenuator having no linear phase shifter 4, it can be seen that the wavelength characteristics of the optical variable attenuator 1 are improved by the linear phase shifter 4. That is, in the case of the optical variable attenuator having the linear phase shifter 4, the difference (flatness) between the maximum and minimum light attenuations of each characteristic line A-E decreases at light attenuations of 20 dB or less. For example, at light attenuations around 15 dB, the flatness is 3 dB in the absence of the linear phase shifter 4 (FIG. 18), whereas it is 1.2 dB in the presence of the linear phase shifter 4 (FIG. 3). At light attenuations around 5 dB, the flatness is 0.9 dB in the absence of the linear phase shifter 4, whereas it is 0.2 dB in the presence of the linear phase shifter 4. This means improvements in wavelength characteristic of light attenuation.

Next, a comparison is made between the temperature characteristics (FIG. 4) in the presence of the linear phase shifter 4 (α=80°, d=350 μm) and the temperature characteristics (FIG. 19) in the absence of the linear phase shifter 4. It is found that the temperature characteristics are improved by the linear phase shifter 4. That is, variations in light attenuation resulting from temperature changes are suppressed. In particular, the effect becomes higher as the light attenuation increases. For example, at light attenuations around 20 dB, the flatness is 6.3 dB in the absence of the linear phase shifter 4 (FIG. 19), whereas it is 0.3 dB in the presence of the linear phase shifter 4 (FIG. 4). This shows a significant improvement in temperature characteristic.

As described above, the crystal optical axis angle α and the thickness d of the linear phase shifter 4 can be set as appropriate to improve the wavelength and temperature characteristics of the optical variable attenuator 1.

The present embodiment has dealt with the case where the optical axis angle a and the thickness d are set so as to improve both the wavelength and temperature characteristics. The optical axis angle a and the thickness d may be set, however, to improve the characteristic on either the wavelength or temperature alone if the dependence of the light attenuation on the other is compensated for by means other than the linear phase shifter 4. In this case, the characteristic to be compensated can be rendered still preferable since consideration need not be given to the other characteristic.

Hereinafter, description will be given of an optical variable attenuator according to a second embodiment of the present invention.

The optical variable attenuator of the second embodiment is much the same as that of the first embodiment in basic configuration. A difference consists in that the first and second polarizers 2 and 5 are replaced with first and second polarization separators 17 and 18 which are shown in FIG. 10. In this connection, the same components as those of the first embodiment will be designated by identical reference numerals. Description thereof will be omitted.

As shown in FIG. 10, the incident- and emergent-side polarization separators 17 and 18 are made of tapered birefringent crystals, and are placed with their crystal axes orthogonal or parallel to each other. In the incident-side polarization separator 17, input signal light is separated into an ordinary ray P1 and an extraordinary ray P2. The rays P1 and P2 have their planes of polarization rotated by the Faraday rotator 3 and are incident on the linear phase shifter 4. Then, the linear phase shifter 4 brings each of the rays P1 and P2 into a polarization state of being separated between a component in the direction of the crystal optical axis of the linear phase shifter 4 and a component orthogonal thereto, with a phase difference Δ. The resultant rays are output through the emergent-side polarization separator 18.

Even in the second embodiment, the crystal optical axis angle α and the thickness d in the direction of light propagation of the linear phase shifter 4 can be set as appropriate so that the wavelength and temperature dependences of the optical variable attenuator, resulting from the Faraday rotator 3, are compensated. This makes it possible to obtain favorable light-attenuation-wavelength and -temperature characteristics.

According to the second embodiment, the wavelength and temperature characteristics of the optical variable attenuator 1 can be improved. In addition, the polarization dependence can be suppressed. In the second embodiment, since the polarizers 2 and 5 are replaced with the polarization separators 17 and 18, incident light of any polarization can be converted into two linearly polarized rays, or an ordinary ray component and an extraordinary ray component, with little loss.

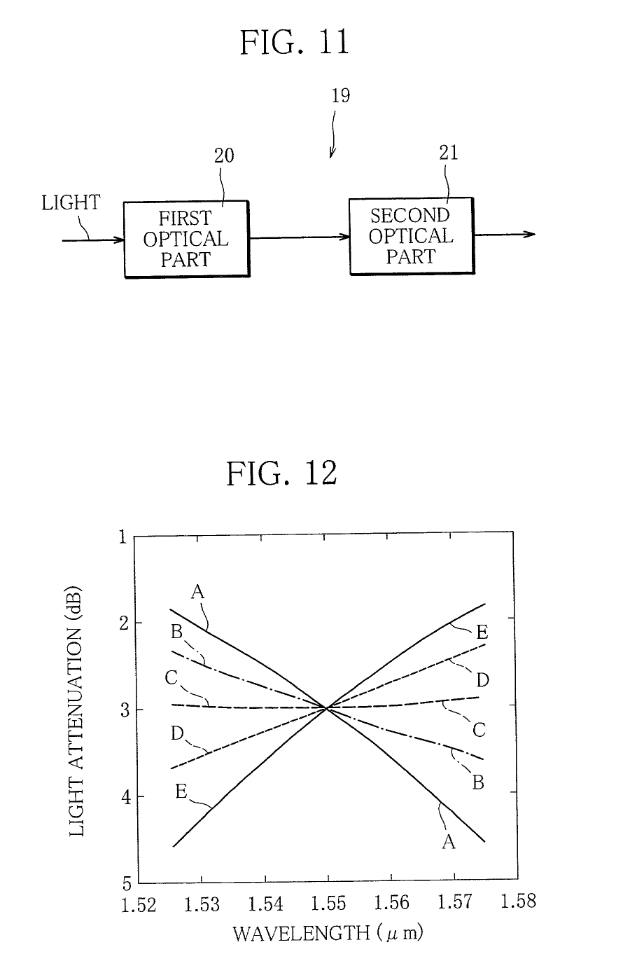

Now, an optical component module according to a third embodiment of the present invention will be described with reference to FIG. 11. In FIG. 11, the same components as those of the first and second embodiments will be designated by identical reference numerals. Description thereof will be omitted.

The present inventors noted that, in an optical variable attenuator (generally, an optical component) providied with a linear phase shifter having a crystal optical axis a and a thickness d in the direction of light propagation that are properly set, the wavelength characteristic of the optical variable attenuator can be variably controlled as shown in FIG. 12, by varying the Faraday rotation angle θ of a Faraday rotator. Based on the above recognition, the present inventors have created an optical component module.

FIG. 12 shows the light-attenuation-wavelength characteristic of the optical variable attenuator 1 in which the linear phase shifter 4 made of quartz, having a thickness d of 503 μm in the direction of light propagation, is placed at a crystal optical axis angle α of 45°. In FIG. 12, the lines A-E correspond to Faraday rotation angles θ of 90°, 60°, 45°, 30°, and 0°, respectively. As can be seen from FIG. 12, the light-attenuation-wavelength characteristic of the second optical component 21 varies in many ways when the Faradary ratation angle θ is changed under the condition that the optical axis angle α and the thickness d of the linear phase shifter 4 are constant.

As shown in FIG. 11, the optical component module 19 of the present embodiment, created based on the aforesaid recognition, comprises a first optical component 20 having a wavelength characteristic to be compensated and a second optical component 21 having a variable wavelength characteristic for compensation. These optical components 20 and 21 are placed on an optical propagation path in this order as seen in the direction of light propagation. Incidentally, the optical components are not limited to this order of arrangement, and may be placed in order of the second optical component 21 and the first optical component 20 along the direction of light propagation.

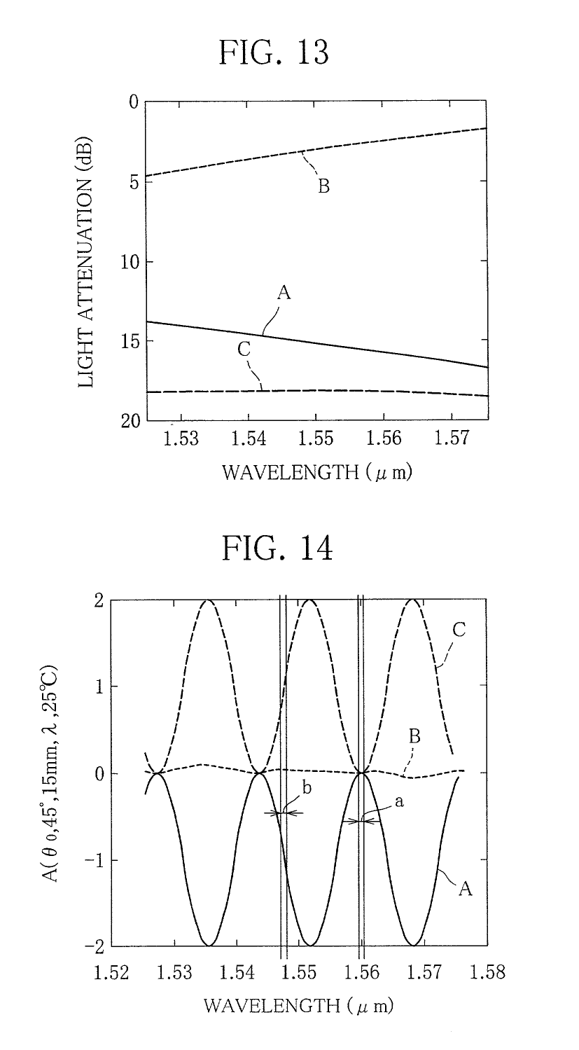

The first optical component 20, for example, comprises a polarizer 2, a Faraday rotator 3, and an analyzer 5 that are arranged on the optical propagation path in this order like the optical variable attenuator 1′ shown in FIG. 17. At a certain Faraday rotation angle, the first optical component 20 has the light-attenuation-wavelength characteristic as shown by the full line A in FIG. 13.

The second optical component 21, for example, has a Faraday rotator 3 and a linear phase shifter 4 like the optical variable attenuator 1 shown in FIG. 1 or 10. The material (type of the birefringent crystal), the crystal optical axis angle α, and the thickness d in the direction of light propagation of the linear phase shifter 4 are selected as appropriate so that the light-attenuation-wavelength characteristic of the second optical component 21 varies in accordance with the Faraday rotation angle θ of the Faraday rotator 3 and has a variable range capable of compensating a change in the wavelength characteristic of the first optical component 20. The second optical component 21 has the light-attenuation-wavelength characteristic shown by the dotted line B in FIG. 13 at a certain Faraday rotation angle θ.

In the optical component module 19, the wavelength dependence of the light attenuation of the first optical component 20, shown by the line A in FIG. 13, is compensated for by the wavelength dependence of the light attenuation of the second optical component 21, shown by the line B in FIG. 13. Thereby, the optical component module 19 exhibits a favorable light-attenuation-wavelength characteristic in which the light attenuation hardly varies with wavelengths, as shown by the broken line C in FIG. 13. Even if there occurs a change in the wavelength characteristic of the light attenuation of the first optical component 20, such a favorable wavelength characteristic can be achieved by changing the Faraday rotation angle θ of the second optical component 21.

As described above, the optical component module 19 is characterized in that the light-attenuation-wavelength characteristic of the second optical component 21 can be varied with the change in the wavelength characteristic of the first optical component 20, thereby compensating for such a characteristic change in the first optical component. To this end, in the second optical component 21, the material, the crystal optical axis angle α, and the thickness d of the linear phase shifter 4 are set as appropriate.

Hereinafter, description will be given as to the reason why the wavelength characteristic of the second optical component 21 (optical variable attenuator 1) provided with such a linear phase shifter 4 can be variably controlled by varying the Faraday rotation angle θ.

As mentioned previously, the light attenuation L of the optical component having no linear phase shifter 4 is given by the foregoing equation (2). In contrast, the light attenuation L1 of the optical component having the linear phase shifter 4 is expressed by the foregoing equation (4) which is equivalent to the equation (2) having the function A(θ0,α,d,λ,T) added to its antilogarithmic term.

The function A(θ0,α,d,λ,T) has a wavelength characteristic so that its value may change with the change in wavelength. FIG. 14 shows the wavelength characteristic of the function A as to the optical component including the linear phase shifter 4 that has a thickness d as extremely great as 15 mm. In FIG. 12, the lines A-C correspond to Faraday rotation angles θ of 0°, 45°, and 90°, respectively.

As shonw in FIG. 14, the function A makes sinusoidal changes in response to wavelength variations. The cycle of the changes varies depending on the thickness d of the linear phase shifter 4. Specifically, the cycle extends as the linear phase shifter 4 decreases in the thickness d.

The function A for a case where the thickness d of a linear phase shifter is extremely great as 15 mm has the wavelength characteristic as shown in FIG. 14 in a waveband of 1.525-1.575 μm. On the other hand, the function A pertaining to an optical component including a linear phase shifter that has a smaller thickness d, e.g., on the order of several hundreds of micrometers exhibits a wavelength characteristic equivalent to one that is obtainable by extending a portion (corresponding to a narrow wavelength region a or b shown in FIG. 14) of the wavelength characteristic shown in FIG. 14 across the entire waveband of 1.525-1.575 μm. Specifically, when the thickness d is 350 μm, the wavelength characteristic of the function A in the entire waveband corresponds to that of the region a in FIG. 14. When the thickness d is 503 μm, the wavelength characteristic corresponds to that of the region b in FIG. 14. In this manner, the wavelength characteristic, especially the cycle of the sinusoidal changes, of the function A(θ0,α,d,λ,T) across the entire waveband varies depending on the thickness d of the linear phase shifter 4.

The functions A(θ0,α,d,λ,T) and cos 2θ(θ0,λ,T) included in the equation (4) have values that change with the change in wavelength. Furthermore, the manner of changing of the values of the functions A and cos 2θ with the change in wavelength varies in dependence on the crystal optical axis angle a of the linear phase shifter 4 and the Faraday rotation angle θ.

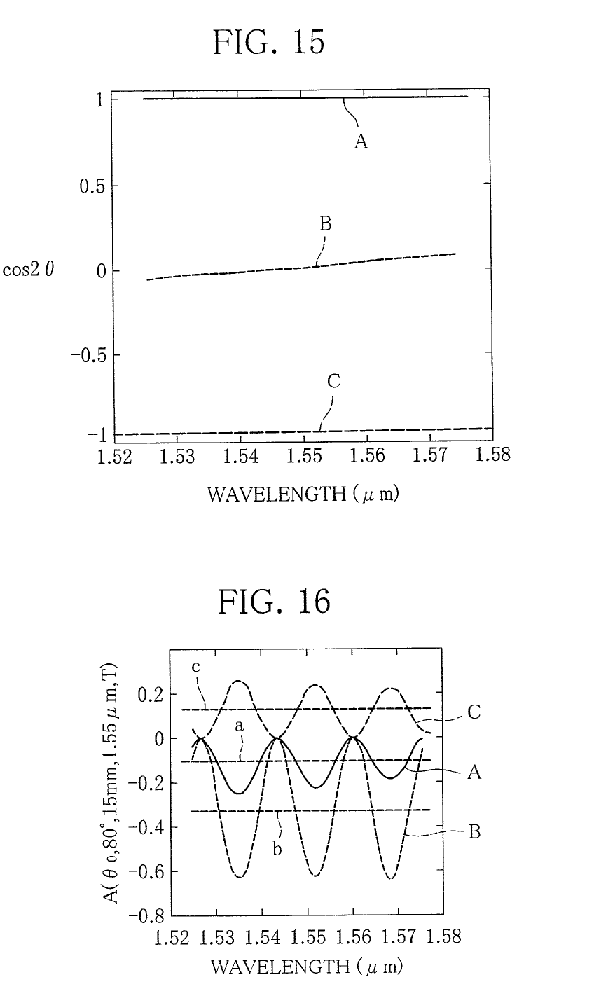

FIG. 14 shows the wavelength characteristic of the function A for a case where a linear phase shifter made of quartz and having a thickness d of 15 mm is placed at an optical axis angle α of 45°. FIG. 15 shows by way of example the wavelength characteristic of the function cos 2θ(θ0,λ,T) for a case where the same linear phase shifter is placed at the same optical axis angle α. FIG. 16 shows the wavelength characteristic of the function A determined at a temperature T of 25° C. in respect of an optical component in which the same linear phase shifter is was placed at an optical axis angle α of 80°. In FIGS. 14-16, the function-wavelength characteristic lines A-C correspond to Faraday rotation angles θ of 0°, 45°, and 90°, respectively.

As for the second optical component 21 (optical variable attenuator 1), it is preferable that the functions A and cos 2θ change in the opposite directions with the change in Faraday rotation angle θ, so that amounts of change in these functions may be cancelled out each other. As illustrated in FIG. 15, the value of the function cos 2θ decreases as shown by the lines A, B and C with the increase in Faraday rotation angle 0 from 0° to 45° and to 90°. In the case shown in FIG. 14, the value of the function A increases with the increase in Faraday rotation angle θ, so that amounts of change in the functions A and cos 2θ are cancelled each other when the Faraday rotation angle θ changes. On the other hand, in the case shown in FIG. 16, the value of the function A decreases as shown by the lines A and B when the Faraday rotation angle θ increases from 0° to 45°, and increases as shown by the lines B and C when the Faraday rotation angle θ increases from 45° to 90°. Thus, amounts of change in the functions A and cos 2θ with the change in Faraday rotation angle θ are not cancelled each other. A conclusion drawn from the above is that the linear phase shifter is preferably placed at an optical axis angle a of 45° rather than 80°.

By setting both the optical axis angle α and the thickness d of the linear phase shifter to appropriate values, it is possible not only to cancel out amounts of change in the functions A and cos 2θ caused by the change in Faraday rotation angle θ but also to desirably change the gradient of the light-attenuation-wavelength characteristic line as the Faraday rotation angle θ changes. For instance, by setting the optical axis angle a and the thickness d at 45° and 503 μm, respectively, the gradient of the wavelength characteristic line of the second optical component 21 can be varied as originally intended in accordance with the Faraday rotation angle θ, as shown shown in FIG. 12.

Specifically, in the case shown in FIG. 12, the light attenuation has a constant value independent of the Faraday rotation angle θ at the set center wavelength λ0 (1.55 μm).

Further, the light-attenuation-wavelength characteristic line rotates, as shown by the characteristic lines A-E, around the constant value when the Faraday rotation angle θ changes from 90° to 0° in the order of 90°, 60°, 45°, 30° and 0°, so that the gradient of the characteristic line gradually changes from a negative large value to a positive large value. Meanwhile, the wavelength (1.55 μm, in FIG. 12) at which the light attenuation has the constant value independent of the Faraday rotation angle varies with a change in the thickness d of the linear phase shifter 4.

Ultimately, the light-attenuation-wavelength characteristic of the second optical component 21, provided with the linear phase shifter having an optical axis angle a and a thickness d that are appropriately set, can be variably controlled by changing the Faraday rotation angle θ. The variable control of the wavelength characteristic of the second optical component 21 makes it possible to compensate for the wavelength characteristic of the first optical component 21, whereby the optical component module 19 having the favorable wavelength characteristic can be attained.

As mentioned above, the present embodiment has dealt with a method of compensating for the wavelength characteristic of the first optical component 20. In addition to this, the temperature characteristic of the first optical component 20 can be compensated for by applying the method of compensating for a temperature characteristic described in the first embodiment. Furthermore, both the wavelength and temperature characteristics may be compensated for.

The present invention is not limited to the first through third embodiments described above, and various modifications may be made thereto.

The first and second embodiments have dealt with the cases where the optical component to be subjected to characteristic improvements is an optical variable attenuator. Nevertheless, the present invention may be applied to various optical components other than optical variable attenuators. Even in such cases, the optical axis angle α and the thickness d of the linear phase shifter 4 can be set as appropriate to improve at least either one of the wavelength and temperature characteristics of the optical components. Similarly, in the third embodiment, the first optical component 20 to be compensated is not limited to an optical variable attenuator, either. That is, various optical components having a wavelength characteristic and/or a temperature characteristic to be desirably compensated may be combined with the compensating optical component 21 to constitute optical component modules.

In each of the foregoing embodiments, the linear phase shifter 4 is arranged at the subsequent stage of the Faraday rotator 3. However, the linear phase shifter 4 may be arranged in the prior stage-of the Faraday rotator 3.

What is claimed is:

1. An optical component comprising:
an optical component element having a wavelength dependence and a temperature dependence in polarization transformation; and
a linear phase shifter arranged on an optical propagation path together with said optical component element, and wherein a type of a birefringent crystal constituting said linear phase shifter, a direction of an optical axis of said linear phase shifter, and a thickness of said linear phase shifter in a direction of light propagation are selected so that said linear phase shifter has at least either one of such wavelength and temperature dependences in polarization transformation as allow compensation for at least either one of the wavelength and temperature dependences of said optical component element.

2. The optical component according to claim 1, wherein:
said optical component element is a Faraday rotator for rotating a plane of polarization of incident light in accordance with a magnitude of an applied magnetic field in the direction of light propagation; and
the optical component is constituted as an optical variable attenuator.

3. The optical component according to claim 2, further comprising field applying and controlling means having an electromagnet arranged so as to be capable of applying a magnetic field to said Faraday rotator, and wherein
said field applying and controlling means variably controls an amount of a current supplied to said electromagnet to variably control a magnitude of magnetization of said Faraday rotator in the direction of light propagation.

4. The optical component according to claim 1, further comprising first and second polarizers arranged on an incident side of said optical component element and an emergent side of said linear phase shifter, respectively, as seen in the direction of light propagation.

5. The optical component according to claim 1, further comprising first and second polarization separators arranged on an incident side of said optical component element and an emergent side of said linear phase shifter, respectively, as seen in the direction of light propagation.

6. The optical component according to claim 1, wherein the type of said birefringent crystal, and the direction of said optical axis and the thickness of said linear phase shifter are set on the basis of at least either a first combination of the direction of said optical axis and the thickness of said linear phase shifter such as minimizes a variation in the light attenuation of the optical component with respect to a change in wavelength across the entire range of wavelength changes of the incident light on the optical component or a second combination of the direction of said optical axis and the thickness of said linear phase shifter such as minimizes a variation in the light attenuation of the optical component with respect to a change in temperature across the entire range of temperature changes of the ambient temperature of the optical component.

7. An optical component module comprising:
a first optical component having a wavelength dependence and a temperature dependence in light attenuation; and
a second optical component having a linear phase shifter and being arranged on an optical propagation path together with said first optical component, and wherein
a type of a birefringent crystal constituting said linear phase shifter, a direction of an optical axis of said linear phase shifter, and a thickness of said linear phase shifter in a direction of light propagation are selected so that said linear phase shifter has at least either one of such wavelength and temperature dependences in light attenuation as allow compensation for at least either one of the wavelength and temperature dependences of said first optical component.

8. The optical component module according to claim 7, wherein each of said first and second optical components is an optical variable attenuator including a Faraday rotator for rotating a plane of polarization of incident light in accordance with a magnitude of an applied magnetic field in the direction of light propagation.

9. The optical component module according to claim 8, wherein:
each of said first and second optical components further comprises field applying and controlling means having an electromagnet arranged so as to be capable of applying a magnetic field to said Faraday rotator; and
said field applying and controlling means variably control an amount of a current supplied to said electromagnet to variably control a magnitude of magnetization of said Faraday rotator in the direction of light propagation.

10. The optical component module according to claim 7, further comprising first and second polarizers arranged on an incident side of said optical component element and an emergent side of said linear phase shifter, respectively, as seen in the direction of light propagation.

11. The optical component module according to claim 7, wherein said second optical component further comprises an optical component element and first and second polarization separators arranged on an incident side of said optical component element and an emergent side of said linear phase shifter, respectively, as seen in the direction of light propagation.

12. The optical component module according to claim 7, wherein the type of said birefringent crystal, and the direction of said optical axis and the thickness of said linear phase shifter are set on the basis of at least either a first combination of the direction of said optical axis and the thickness of said linear phase shifter such as minimizes a variation in the light attenuation of the optical component module with respect to a change in wavelength across the entire range of wavelength changes of the incident light on the optical component module or a second combination of the direction of said optical axis and the thickness of said linear phase shifter such as minimizes a variation in the light attenuation of the optical component module with respect to a change in temperature across the entire range of temperature changes of the ambient temperature of the optical component module.
